(19) United States
(12) Patent Application Publication
(10) Pub. No.: US 2012/0085313 A1
(43) Pub. Date: Apr. 12, 2012

(54) PISTON-HEAD DESIGN FOR USE IN AN INTERNAL COMBUSTION ENGINE

(76) Inventor: Heinz-Gustav A. Reisser, Coshocton, OH (US)

(21) Appl. No.: 12/902,381

(22) Filed: Oct. 12, 2010

(51) Int. Cl. F02F 3/00; F16J 9/06; F16J 1/14

(52) U.S. Cl. 123/193.6; 92/187; 277/472

(57) ABSTRACT

A piston assembly for use in an internal combustion engine is provided by the present disclosure. The piston assembly includes a piston body having an extended piston mantel, a piston face, an internal cavity, and a wrist pin support. Two oil retainer seals are located concentrically about the extended piston mantel near a distal end, each oil retainer seal having an internal groove and being formed of a polymer material. Two compression clips are disposed within the internal grooves of the two oil retainer seals and are adapted to assist the oil retainer seals in establishing contact with an inner wall of a cavity in a cylinder of the internal combustion engine. The piston body is formed of an engineered composite material.

### FIELD

The present disclosure relates to the design and construction of piston assemblies used in steam or internal combustion engines, including in rotary engines.

### BACKGROUND

The statements in this section merely provide background information related to the present disclosure and may not constitute prior art. In conventional combustion engines, the walls delimiting combustion chambers are of a cylindrical shape and closed on one end with a cylinder head. A piston is moveably guided through the other end into the cylinder. Internal combustion engines have 4 basic steps: (1) intake; (2) compression; (3) combustion and expansion; and (4) exhaust. During the intake step, combustible mixtures are injected into the combustion chamber. This mixture is placed under pressure by the compression of the piston into the cylinder. The mixture is then ignited and burnt. The hot combustion products ultimately expand; forcing the piston to move in the opposite direction and causing the transfer of energy to mechanical components that are coupled or connected to the piston, such as a crank shaft. The cooled combustion products are finally exhausted and the combustion cycle restarts. These conventional combustion engines generally suffer from low efficiency, large size, high weight, and the need to use and continually replenish an external, liquid lubricant.

The introduction of rotary engine assemblies in recent years have provided improvements related to increased engine efficiency and reduced engine size. However, in order to provide further improvements related to a reduction in the weight of the engine and a reduction in the need for external lubricants, the development and use of new materials has been beneficial. Continued advancements with the design of advanced engine components and new materials is continally desired in the field of internal combustion engines.

### SUMMARY

The present disclosure provides a piston assembly for use in a steam engine or an internal combustion engine that improves engine efficiency, reduces the weight, size, and amount of external lubricants used in an engine, reduces the contamination of combustion chambers in the engine from such lubricants, and simplifies the ability to manufacture such a piston assembly. The piston assembly may be employed in any type of engine, including but not limited to, a conventional reciprocating engine, a rotary engine, and a radial engine, among others. Accordingly, the reference to a specific type of engine as set forth herein should not be construed as limiting the scope of the present disclosure.

In one form of the present disclosure, a piston assembly for use in an internal combustion engine is provided that comprises a piston body having an extended piston mantel with a proximal end and a distal end, a piston face disposed at the distal end of the extended piston mantel, an internal cavity, and a wrist pin support disposed at the proximal end of the extended piston mantel. Two oil retainer seals are located concentrically about the extended piston mantel near the distal end, each oil retainer seal having an internal groove and being formed of a polymer material. Two compression clips are disposed within the internal grooves of the two oil retainer seals. The piston body is formed of an engineered composite material, and the compression clips are adapted to assist the oil retainer seals in establishing contact with an inner wall of a cavity in a cylinder of the internal combustion engine.

According to another form of the present disclosure, an internal combustion engine is provided that comprises a plurality of piston head assemblies. Each piston assembly comprises a piston body having an extended piston mantel with a proximal end and a distal end, a piston face disposed at the distal end of the extended piston mantel, an internal cavity, and a wrist pin support disposed at the proximal end of the extended piston mantel. Two oil retainer seals are located concentrically about the extended piston mantel near the distal end, each oil retainer seal having an internal groove and being formed of a polymer material. Two compression clips are disposed within the internal grooves of the two oil retainer seals. The piston body is formed of an engineered composite material, and the compression clips are adapted to assist the oil retainer seals in establishing contact with an inner wall of a cavity in a cylinder of the internal combustion engine.

According to still another form of the present disclosure, an oil retainer assembly for use with a piston of an internal combustion engine is provided. The oil retainer assembly comprises an oil retainer seal having an internal groove and being formed of a polymer material and a compression clip disposed within the internal grooves of the oil retainer seal. The compression clip is adapted to assist the oil retainer seal in establishing contact with an inner wall of a cavity in a cylinder of the internal combustion engine.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way. It should be understood that throughout the description and drawings, corresponding reference numerals indicate like or corresponding parts and features.

FIG. 1A is a perspective view of an exemplary rotary internal combustion engine highlighting the use of piston assemblies constructed according to the teachings of the present disclosure;

FIG. 1B is a cross-sectional view of an exemplary reciprocating V-type internal combustion engine highlighting the use of another form of piston assemblies constructed according to the teachings of the present disclosure;

FIG. 2A is perspective side view of a piston assembly used in the reciprocating internal combustion engine of FIG. 1B and constructed according to the teachings of the present disclosure;

FIG. 2B is a side view of the piston assembly of FIG. 2A in accordance with the teachings of the present disclosure;

FIG. 2C is a bottom view of the piston assembly of FIG. 2A in accordance with the teachings of the present disclosure;

FIG. 2D is a top view of the piston assembly of FIG. 2A in accordance with the teachings of the present disclosure;

FIG. 3 is a perspective view of a oil retainer seal used in conjunction with the piston assembly in accordance with the teachings of the present disclosure;

FIG. 4 is a perspective view of a compression clip used in conjunction with the oil retainer seal of FIG. 3 in accordance with the teachings of the present disclosure;

FIG. 5A is perspective view of a piston assembly used in the rotary engine of FIG. 1A and constructed constructed in accordance with the teachings of the present disclosure;

FIG. 5B is a side view of the piston assembly of FIG. 5A in accordance with the teachings of the present disclosure;

FIG. 5C is a bottom view of the piston assembly of FIG. 5A in accordance with the teachings of the present disclosure;

FIG. 5D is a top view of the piston assembly of FIG. 5A in accordance with the teachings of the present disclosure.

### DETAILED DESCRIPTION

The following description is merely exemplary in nature and is in no way intended to limit the present disclosure or its application or uses. The present disclosure generally provides an improved design of a piston assembly for use in a steam engine or an internal combustion engine capable of driving a vehicle or accessory equipment. The improved piston assembly design provides multiple benefits, namely, providing for the use ceramic or carbon composites that reduce the weight of the piston, simplifies one's ability to manufacture the piston, reduces the use of external lubricants, and lowers the chance that a combustion chamber may become contaminated with an external lubricant.

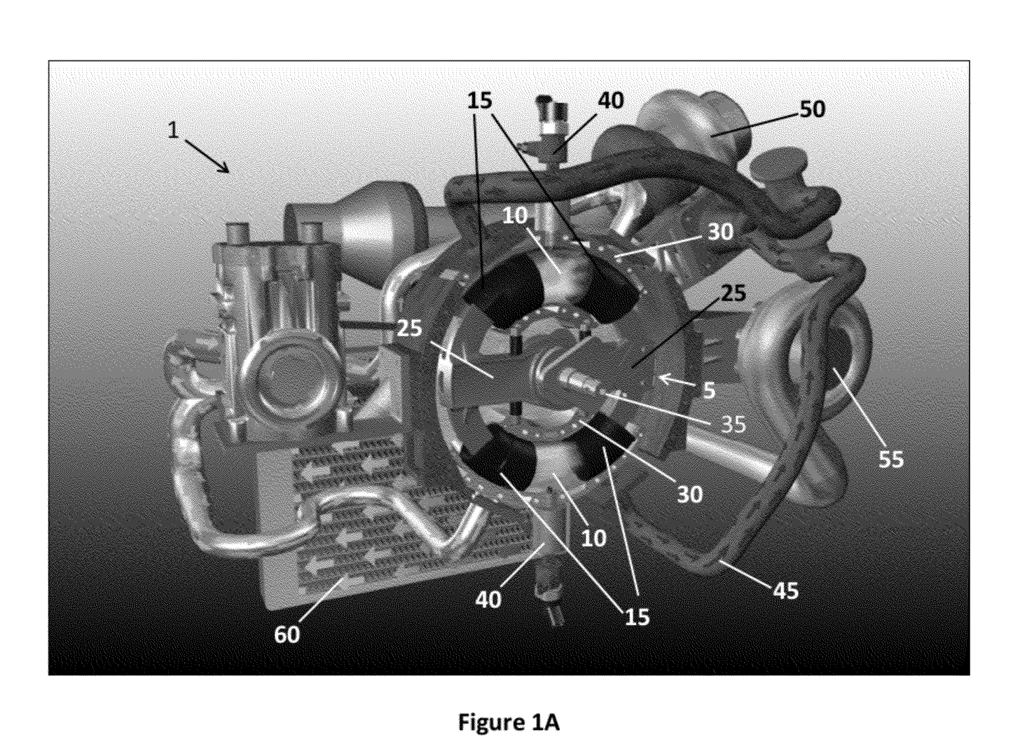

Referring to FIG. 1A, an example of a rotary internal combustion engine assembly 1 is shown in which the engine 5 includes multiple combustion chambers 10 arranged in a toroidal geometry. Each combustion chamber 10 is delimited by two piston assemblies 15 positioned on different primary members 25 that move in opposite directions and by the wall of a cavity located within a cylinder liner 30. A plurality of crankshafts 35 are positioned within the diameter of the toriodal path of the primary members 25. The engine assembly 1 may further comprise multiple injectors 40 adapted to inject fuel into one of the combustion chambers and a forced charge air system that includes exhaust ducting 45, a turbocharger 50 and/or a supercharger 55. Both the supercharger 55 and the turbocharger 50 provide air to maintain a constant pressure, thereby, allowing each of the combustion chambers 10 in the engine assembly 1 to draw (e.g., scavenge) air once the piston assemblies 15 are separated and the flow of air can enter the combustion chamber 10 by means of openings in the cylinder liners 30. The fresh air charge for the engine assembly 1 may be passed by or through a cooling system 60 prior to it being scavenged or drawn into one of the combustion chambers 10. A thorough description of a rotary steam and/or combustion engine in which the piston assembly of the present disclosure may be used can be found in U.S. application Ser. No. 12/849,406 filed Aug. 3, 2010, which is a continuation-in-part of application Ser. No. 12/97,522 filed Aug. 25, 2008, which is a continuation-in-part of application Ser. No. 11/304,608, filed Dec. 16, 2005, now U.S. Pat. No. 7,415,962, the entire contents of which are hereby incorporated by reference.

As shown in FIG. 1B, a portion of a conventional reciprocating engine 70 is shown, in which the claimed piston design is also employed. The piston assemblies 15 are shown within respective cylinders 72 and are connected to a crankshaft 74 by respective connecting rods 76. (A portion of the piston assembly 15 on the right-hand side is only partially shown due to the cross-sectional plane of FIG. 1B). The operation of a conventional V-type reciprocating internal combustion engine is known in the art and thus is not set forth in greater detail herein for purposes of clarity. An exemplary V-type reciprocating internal combustion engine is described in greater detail in U.S. Pat. No. 4,936,265, which is incorporated herein by reference in its entirety.

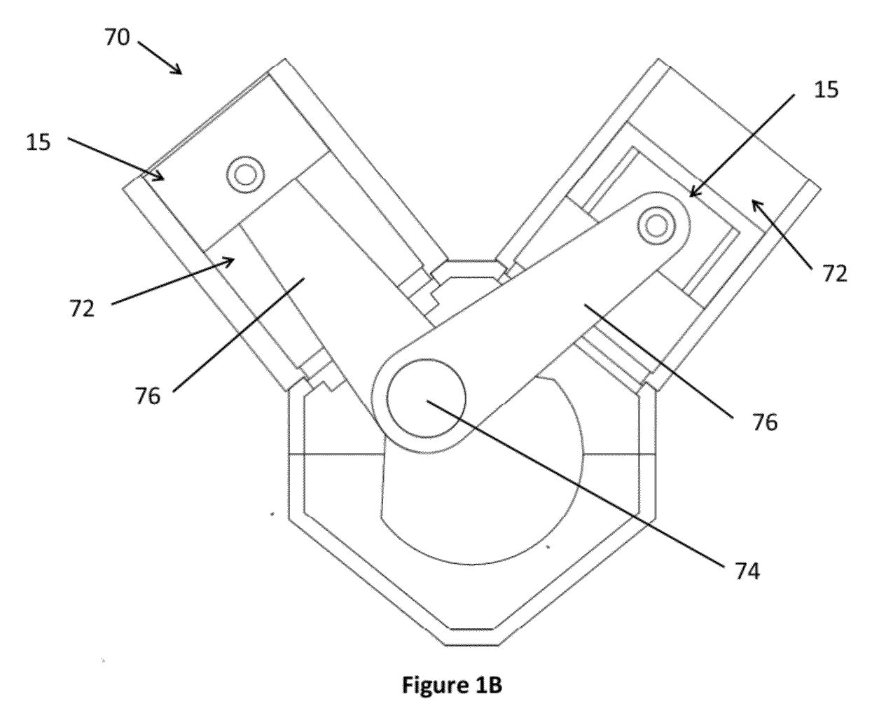

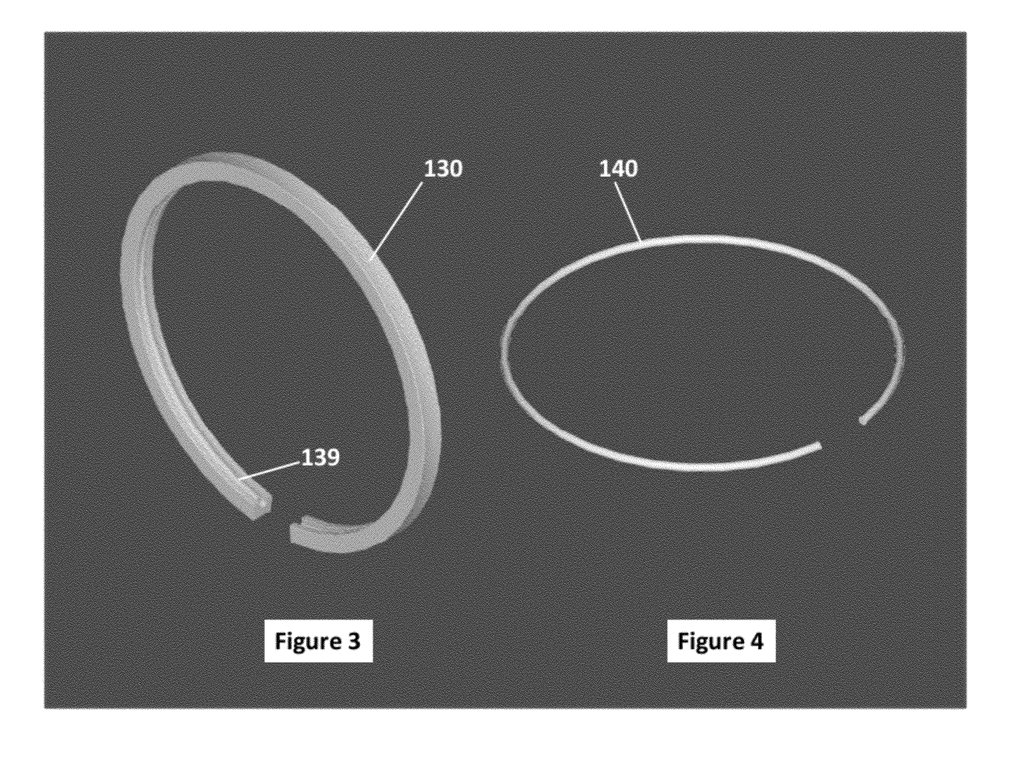

Referring now to FIGS. 2A-2D the piston assembly 15 includes a piston body 89, a wrist pin support 90, an extended piston mantel 100, an internal cavity 110, a piston face 120, two oil retainer seals 130 (only one is shown in FIG. 2B), and two corresponding compression clips 140 (shown in FIG. 4). The wrist pin support 90 and the internal cavity 110 are utilized to couple the piston assembly 15 to connecting rods of an internal combustion engine. The oil retainer seals 130 keep any oil splatter that may be present on the inner wall of cylinder liners from being transported through contact with the piston faces 120 and extended piston mantels 100 into a combustion chamber.

Through the implementation of engineered composite materials, such as carbon or ceramic composites, the pistons can be machined with a larger overall diameter keeping the actual cylinder bore diameter constant, thereby, reducing or eliminating the need for a compression ring as used with conventional piston assemblies. Rather one skilled-in-the-art will understand that the piston assemblies 15 of the present disclosure are designed and manufactured such that the outer diameter of the entire piston body 89 may ride closer to the inner wall of the cavity in a cylinder bore. Thus the existence of a concentric gap between the inner wall of the cavity in the cylinder liner and the piston body 89 can be substantially smaller than that conventionally used with pistons in a common engine application. The elimination of this concentric gap elements the need for a compression ring and provides the additional benefit of reducing the occurrence of any “pinging” or excessive engine wear occurring during the operational lifetime of an engine.

The piston assemblies 15 of the present disclosure do not require the presence of a compression ring to achieve a high piston in cylinder compression ratio. Rather the piston assemblies 15 of the present disclosure have been observed to out-perform conventional pistons having compression rings in compression leak tests that are commonly performed by one skilled-in-the-art.

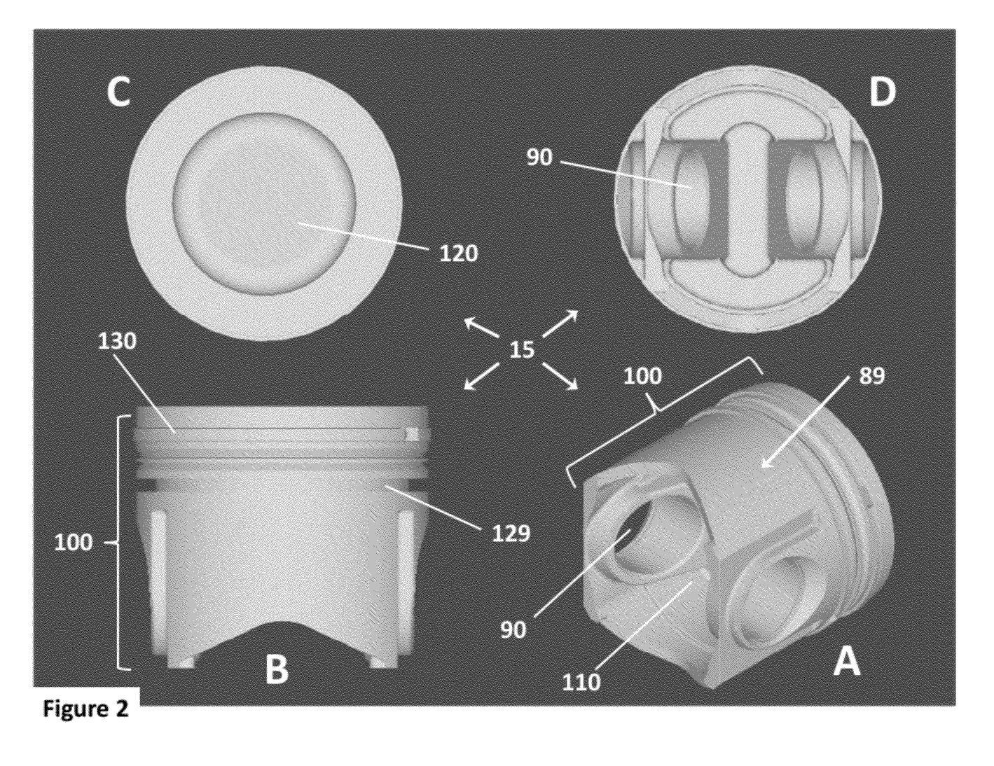

In one form of the present disclosure, there are two oil retainer seals 130 are used in conjunction with each piston head 15. An example of an oil retainer seal 130 designed according to the teachings of the present disclosure is provided in FIG. 3. The overall height and depth of the oil retainer seal 130 depends upon the basic geometry (e.g., diameter) of the piston head 15. These seals 130 are placed into features or grooves 129 that are molded or machined concentrically along the surface of the piston mantel 100.

The oil retainer seal 130 may be made of any type of polymer that is compatible with oils and that can exhibit thermal stability during operation of internal combustion engines. Preferably, the polymer of the oil retainer seal 130 will be constructed of a polymer being dimensionally stable and having significant or high stiffness such as Fluorosint® or any other equivalent PTFE (Polytetrafluoroethylene) thereby, increasing the pressure exerted by the seal onto the wall of the cylinder liner. The stiffness adds to the overall efficiency in the oil retainer seal's ability to “scrape” or retain the oil splashed onto the cylinder liners during normal operation of any type of internal combustion engine to prevent external lubricants (oil) from entering the combustion chambers. Examples of polymeric materials that may be used as an oil retainer seal include polychloroprene, fluorocarbon (FKM) elastomers, silicones (VQM), fluorosilicones (FVMQ), nitrile (NBR) rubber, polyacrylic (ACM) polymers, polyurethane rubbers, ethylene acrylic (AEM) polymers, polyester elastomers, chlorosulfonated polyethylene, and polytetrafluoroethylene (PTFE), among others. Still referring to FIG. 3, the oil retainer seal 130 has a contacting surface that is elliptical in shape (e.g., concave) and adapted to interact with the inner wall of a cylinder liner.

Referring once again to FIGS. 2A and 2B, a compression clip 140 may be positioned proximate to each oil retainer seal 130. An example of a compression clip 140 is provided in FIG. 4. The compression clip 140 forces the oil retainer seal 130 to spread apart, thereby, providing a greater amount of surface pressure to interact with the inner wall of a cylinder liner. The compression clip 140 is capable of causing the oil retainer seal 130 to spread apart by being fit into a feature or groove 139 that is molded or cut into the oil retainer seal 130 as shown in FIG. 3. The cut or groove 139 may be semi-circular to the circumference of the seal, so that a round bar compression clip 140 may be used to firmly seat against the seal 130.

The compression clip may be made from any metal or metal alloy known to one skilled-in-the-art, including but not limited to mild steel, copper, cupro-nickel (i.e., Monel®, Special Metals Corp.), nickel, stainless steel, and nickel-chromium (i.e., Inconel®, Special Metals Corp.), among others. The compression clip may represent a solid ring or a ring having a hollow inner core. The compression clip may include a combination of the metal alloys in the form of a solid inner core and an external plating or coating surrounding the inner core.

During operation of the engine, having the compression clip 140 inserted into the center of the oil retainer seal 130 along with having the surface of the seal 130 that makes contact with the inner wall of a cylinder liner be concave in shape, causes the seal 130 to flex such that two to three concentric regions of contact may be created between the seal 130 and the wall of the cylinder liner. These concentric contact regions are capable of acting as “oil scrappers” and to keep any oil splatter from entering a combustion chamber 10.

One skilled-in-the-art will understand that multiple factors are involved in predetermining the dimensions of the oil retainer seal 130 and its associated groove or cut 139. Such factors, may include, but not be limited to flexural modulus, thermal coefficient of expansion, and the interaction with thermal expansion factors associated with the compression clip 140.

Each piston body 89 may be comprised of a carbon composite or a ceramic composite among others. Examples of carbon and ceramic composites may include silicon carbide, silicon nitride, and graphite among others. Further, the composite construction may include discontinuous fiber-reinforced carbon or ceramic, wherein the fibers may include, by way of example, glass, carbon, or graphite. When the piston body 89 is made of a graphite composite, the magnitude of the frictional forces resulting from contact between the piston body 89 with other components in the internal combustion engine will be low. Thus one benefit of using a carbon composite, such as graphite, is that the need for the use of a oil or other external lubricant to reduce the amount of friction between moving parts or components in the engine assembly 1 is either reduced or eliminated entirely.

The piston bodies 89 may be either completely solid or partially hollow depending upon the weight requirements for the intended application. The strength of carbon and ceramic composites may be enhanced through the use of fiber reinforcement.

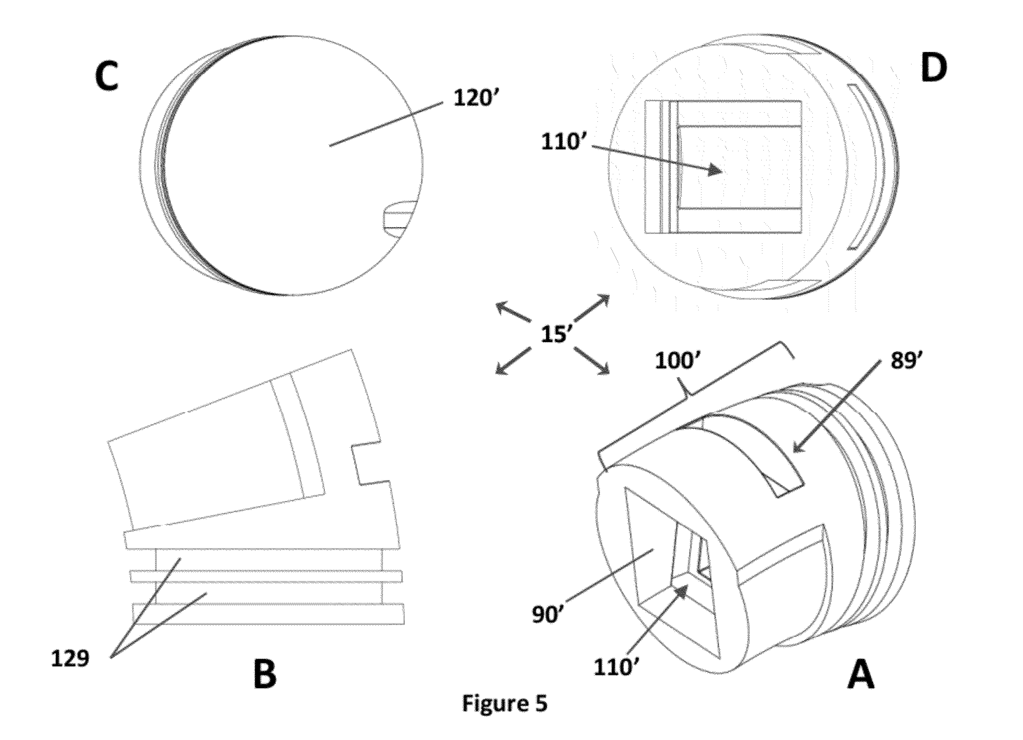

Referring now to FIGS. 5A-5D, another form of the piston assembly 15′ is shown, which is used with the rotary internal combustion engine of FIG. 1A. As with the previous piston assembly 15, this rotary engine piston assembly 15′ includes a piston body 89′, a primary member support 90′, an extended piston mantel 100′, an internal cavity 110′, a piston face 120′, two oil retainer seals 130 (shown in FIG. 3) that are disposed within grooves 129′, and two corresponding compression clips 140 (shown in FIG. 4). The primary member support 90′ and the internal cavity 110′ are utilized to couple the piston assembly 15′ to primary members 25 of an internal combustion engine. The oil retainer seals 130 keep any oil splatter that may be present on the inner wall of cylinder liners from being transported through contact with the piston faces 120′ and extended piston mantels 100′ into a combustion chamber. The engineering materials and operation of this piston assembly 15′ are the same as those as set forth above in connection with the conventional V-type internal combustion engine and thus are not repeated herein for purposes of clarity. Therefore, it should be understood that the piston assemblies according to the present disclosure may be employed in any type of engine while remaining within the scope of the claimed invention.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A piston assembly for use in an internal combustion engine comprising:
a piston body comprising:
an extended piston mantel having a proximal end and a distal end;
a piston face disposed at the distal end of the extended piston mantel;
an internal cavity; and
a wrist pin support disposed at the proximal end of the extended piston mantel;
two oil retainer seals, the oil retainer seals located concentrically about the extended piston mantel near the distal end, each oil retainer seal having an internal groove and being formed of a polymer material; and
two compression clips, the compression clips being disposed within the internal grooves of the two oil retainer seals,
wherein the piston body is formed of an engineered composite material, and the compression clips are adapted to assist the oil retainer seals in establishing contact with an inner wall of a cavity in a cylinder of the internal combustion engine.

2. The piston assembly of claim 1, wherein the engineered composite material is selected from the group consisting of a carbon composite and a ceramic composite.

3. The piston assembly of claim 2, wherein the carbon composite is fiber reinforced.

4. The piston assembly of claim 2, wherein the carbon composite is graphite.

5. The piston assembly of claim 1, wherein the polymer material of the oil retainer seals is a polytetrafluoroethylene.

6. The piston assembly of claim 1, wherein the polymer material is selected from the group consisting of polychloroprenes, fluorocarbons, silicones, fluorosilicones, nitrile rubber, polyacrylic polymers, polyurethanes, ethylene acrylic polymers, polyester elastomers, chlorosulfonated polyethylene, and a polytetrafluoroethylene.

7. The piston assembly of claim 1, wherein the oil retainer seals have contacting surfaces that are elliptical.

8. The piston assembly of claim 1, wherein the compression clips are made from a metal or a metal alloy.

9. The piston assembly of claim 8, wherein the compression clips are selected from the group consisting of mild steel, copper, copper-nickel alloys, nickel, stainless steel, and nickel-chromium alloys.

10. The piston assembly of claim 1, wherein the compression clips cause the oil retainer seals to make contact with an inner wall of the cavity in the cylinder in at least two concentric regions.

11. An internal combustion engine comprising:
a plurality of piston head assemblies, each piston assembly comprising:
a piston body comprising:
an extended piston mantel having a proximal end and a distal end;
a piston face disposed at the distal end of the extended piston mantel;
an internal cavity; and
a wrist pin support disposed at the proximal end of the extended piston mantel;
two oil retainer seals, the oil retainer seals located concentrically about the extended piston mantel near the distal end, each oil retainer seal having an internal groove and being formed of a polymer material; and
two compression clips, the compression clips being disposed within the internal grooves of the two oil retainer seals,
wherein the piston body is formed of an engineered composite material, and the compression clips are adapted to assist the oil retainer seals in establishing contact with an inner wall of a cavity in a cylinder of the internal combustion engine.

12. The internal combustion engine of claim 11, wherein the internal combustion engine is a reciprocating-type engine.

13. The internal combustion engine of claim 11, wherein the internal combustion engine is a radial engine.

14. The internal combustion engine of claim 11, wherein the internal combustion engine is a rotary engine.

15. An oil retainer assembly for use with a piston of an internal combustion engine, the oil retainer assembly comprising:
an oil retainer seal having an internal groove and being formed of a polymer material; and
a compression clip disposed within the internal grooves of the oil retainer seal,
wherein the compression clip is adapted to assist the oil retainer seal in establishing contact with an inner wall of a cavity in a cylinder of the internal combustion engine.

16. The oil retainer assembly of claim 15, wherein the polymer material of the oil retainer seal exhibits high stiffness.

17. The oil retainer assembly of claim 15, wherein the polymer material is selected from the group consisting of polychloroprenes, fluorocarbons, silicones, fluorosilicones, nitrile rubber, polyacrylic polymers, polyurethanes, ethylene acrylic polymers, polyester elastomers, chlorosulfonated polyethylene, and a polytetrafluoroethylene.

18. The oil retainer assembly of claim 15, wherein the oil retainer seal has a contacting surface that is elliptical in shape.

19. The oil retainer assembly of claim 15, wherein the compression clip is made from a metal or a metal alloy.

20. The oil retainer assembly of claim 19, wherein the compression clip is selected from the group consisting of mild steel, copper, copper-nickel alloys, nickel, stainless steel, and nickel-chromium alloys.

21. The oil retainer assembly of claim 15, wherein the compression clip causes the oil retainer seal to make contact with a inner wall of the cavity in the cylinder in at least two concentric regions.
